(19) United States
(12) Patent Application Publication
(10) Pub. No.: US 2026/0361964 A1
(43) Pub. Date: Nov. 12, 2026

(54) METHOD, APPARATUS, DEVICE AND STORAGE MEDIUM FOR VIEWING AUDIO-VISUAL CONTENT

(71) Applicant: Beijing Zitiao Network Technology Co., Ltd., Beijing (CN)

(72) Inventors: Kang Zheng, Beijing (CN); Ding Zhang, Beijing (CN); Jichao Li, Beijing (CN); Jinghui Liu, Beijing (CN); Jun He, Beijing (CN); Xiang Li, Beijing (CN)

(21) Appl. No.: 19/125,709

(22) PCT Filed: Aug. 16, 2023
(86) PCT No.: PCT/CN2023/113406

§ 371 Date: Apr. 29, 2025

(30) Foreign Application Priority Data
Oct. 31, 2022 (CN) 202211352393.3

(51) Int. Cl. H04N 21/472; H04N 21/431; H04N 21/488

(52) U.S. Cl. CPC H04N 21/47217; H04N 21/4312; H04N 21/4884

(57) ABSTRACT

According to embodiments of the disclosure, a method, an apparatus, a device and a storage medium for viewing an audio-visual content are provided. The method includes providing a viewing interface for the audio-visual content; and presenting at least one speech timeline in the play control. The viewing interface includes a play control for playing the audio-visual content. The at least one speech timeline is configured to indicate a distribution in time of a speech content of at least one speaker associated with the audio-visual content. In this way, with embodiments of the disclosure, it may facilitate the user to obtain the speech time distribution information of each speaker in the audiovisual content, thereby helping the user to more conveniently obtain the required information.

This application claims the benefit of Chinese Patent Application No. 202211352393.3, filed on Oct. 31, 2022, entitled “METHOD, APPARATUS, DEVICE AND STORAGE MEDIUM FOR VIEWING AUDIO-VISUAL CONTENT”, the entire content of which is incorporated herein by reference.

### FIELD

Example embodiments of the present disclosure generally relate to the field of computers, and more particularly, to a method, an apparatus, a device and a computer-readable storage medium for viewing an audio-visual content.

### BACKGROUND

With the development of computer technologies, the Internet has become a main platform for people to obtain and share contents. For example, with the Internet, people may publish a variety of contents, or receive contents shared by other users.

In the Internet-based content sharing, the sharing of audio-visual content (e.g., audio content or video content) has become an important form. For example, people may use a player to play a video, or audio record of a speech or a conference shared by other users. However, during the playing process, it is difficult for people to quickly locate a corresponding portion of a specific speaker in the video or audio record.

### SUMMARY

In a first aspect of the present disclosure, a method for viewing an audio-visual content is provided. The method includes receiving a selection of a plurality of text segments, the plurality of text segments corresponding to a plurality of portions in a target audio-visual content, the plurality of portions at least including a first portion and a second portion that are discontinuous in the target audio-visual content; causing a clip of audio-visual content to be created based at least on the plurality of portions of the target audio-visual content, the first portion and the second portion being continuous in the clip of audio-visual content; and presenting a sharing entry for sharing the clip of audio-visual content.

In a second aspect of the present disclosure, an apparatus for viewing an audio-visual content is provided. The apparatus includes a receiving module configured to receive a selection of a plurality of text segments, the plurality of text segments corresponding to a plurality of portions in the target audio-visual content, the plurality of portions at least including a first portion and a second portion that are discontinuous in the target audio-visual content; a control module configured to cause a clip of audio-visual content to be created based at least on the plurality of portions of the target audio-visual content, the first portion and the second portion being continuous in the clip of audio-visual content; and a presenting module configured to present a sharing entry for sharing the clip of audio-visual content.

In a third aspect of the present disclosure, an electronic device is provided. The electronic device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, a computer-readable storage medium is provided. The medium stores a computer program, and when the program is executed by the processor, the method of the first aspect is implemented.

In a fifth aspect of the present disclosure, a playing system is provided. The playing system includes a primary timeline and at least one speech timeline. The primary timeline at least indicates a current playing position of an audio-visual content. The at least one speech timeline is configured to indicate a distribution in time of a speech content of at least one speaker associated with the audio-visual content.

It should be understood that what is described in this section is not intended to limit the critical features or essential features of the embodiments of the present disclosure, nor is it intended to limit the scope of the present disclosure. Other features of the present disclosure will be readily appreciated from the following description.

### BRIEF DESCRIPTION OF DRAWINGS

These and other aspects and advantages of embodiments of the present disclosure will become apparent and more readily appreciated from the following descriptions made with reference to the drawings. In the drawings, the same or similar reference numerals indicate the same or similar elements, in which:

FIG. 1 illustrates a schematic diagram of a conventional audio-visual content player;

FIGS. 2A-2C illustrate schematic diagrams of example playing systems according to some embodiments of the present disclosure;

FIGS. 3A and 3B illustrate example viewing interfaces of audio-visual contents according to some embodiments of the present disclosure;

FIGS. 4A and 4B illustrate schematic diagrams of sharing a clip of audio-visual content according to some embodiments of the present disclosure;

FIG. 5 illustrates a flowchart of an example process of viewing an audio-visual content according to some embodiments of the present disclosure;

FIG. 6 illustrates a block diagram of an apparatus for viewing an audio-visual content according to some embodiments of the present disclosure; and

FIG. 7 illustrates a block diagram of a device capable of implementing various embodiments of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

In the description of the embodiments of the present disclosure, the term “including” and the like are to be understood as open inclusion, i.e., “including but not limited to”. The term “based on” should be understood as “based at least in part”. The term “one embodiment” or “the embodiment” should be understood as “at least one embodiment”. The term “some embodiments” should be understood as “at least some embodiments”. Other explicit and implicit definitions may also be included below.

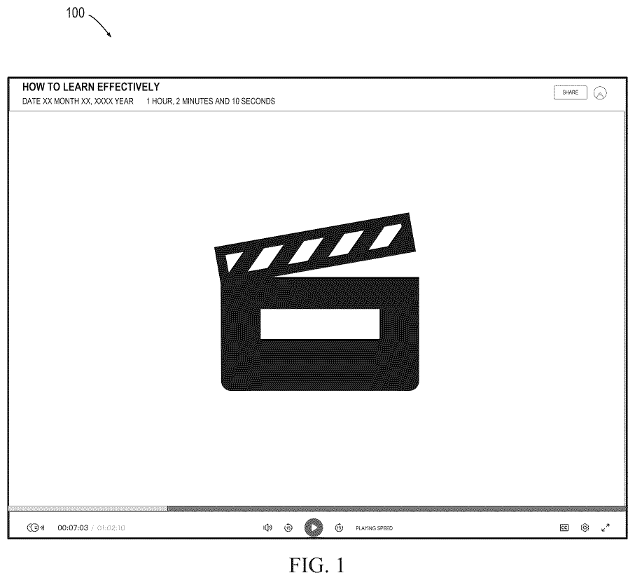

As discussed above, people may acquire an audio-visual content with a player. FIG. 1 illustrates a schematic diagram of a conventional audio-visual content player 100. As illustrated in FIG. 1, in the player 100, people usually need to drag a timeline to locate the desired playing moment.

However, the play control is inefficient. For example, in the example of FIG. 1, the audio-visual content has a length of more than one hour, which makes it difficult for the user to quickly locate the desired playing position through the timeline.

This situation is particularly noticeable in the review of the audio-visual content such as conferences, speeches, or online classes. In the scenario, there are usually a plurality of speakers, and one may expect to quickly locate the speech portion of a specific speaker.

Embodiments of the present disclosure provide a playing system for an audio-visual content (an audio content or a video content). The system may include a primary timeline, indicating at least a current playing position of the audio-visual content. In addition, the system may further include at least one speech timeline. The at least one speech timeline is configured to indicate a distribution in time of a speech content of at least one speaker associated with the audio-visual content.

In addition, embodiments of the present disclosure further provide solutions for viewing the audio-visual content. According to a solution, a viewing interface for the audio-visual content may be provided, and the viewing interface includes a play control for playing audio-visual content. Further, at least one speech timeline may be presented in the play control, and the at least one speech timeline is configured to indicate a distribution in time of the speech content of at least one speaker associated with the audio-visual content.

Based on this manner, embodiments of the present disclosure may provide a speech timeline in the playing system or the play control, to provide the distribution in time corresponding to the speech content of the speaker associated with the audio-visual content. Therefore, with the embodiments of the present disclosure, it is convenient for users to view the corresponding portion of a specific speaker, thereby improving the efficiency of users in obtaining the desired content.

Example solutions according to embodiments of the present disclosure will be described in detail below with reference to the accompanying drawings.

### Example Playing System

In some embodiments, embodiments of the present disclosure may provide richer information about the audio-visual content with the timeline.

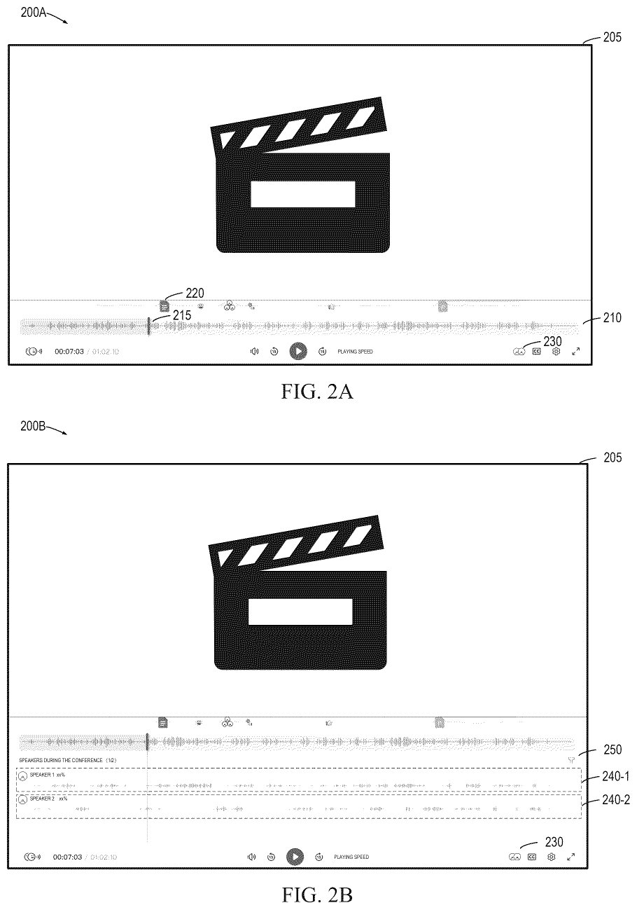

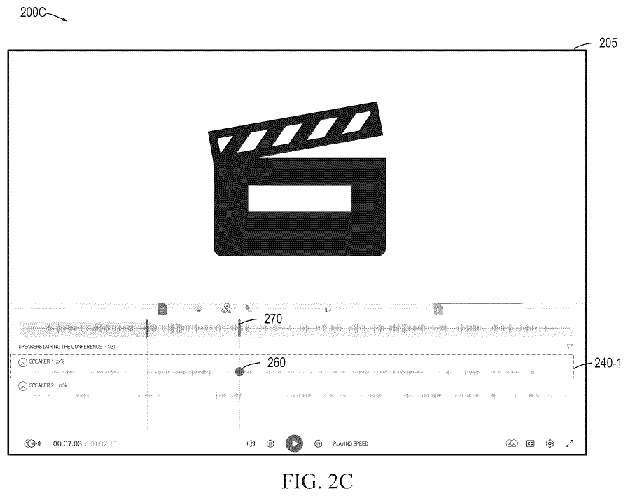

FIG. 2A illustrates a schematic diagram 200A of an example playing system 205 according to some embodiments of the present disclosure. As illustrated in FIG. 2A, a playing system 205 (also referred to as a player 205 or a play control 205) may be configured to play the corresponding audio-visual content. The playing system 205 may be, for example, provided by an appropriate electronic device, and an example of the electronic device may include, but is not limited to, a desktop computer, a notebook computer, a smart phone, a tablet computer, a personal digital assistant, or a smart wearable device.

In some embodiments, the audio-visual content may include an audio-video file locally stored in the playing system 205, an audio-video file stored in a cloud, or an audio-video stream. The audio-video stream may include, for example, a playing stream of a recorded audio-visual content (e.g., a conference record), or a live stream of the live audio-visual content.

### Primary Timeline

As illustrated in FIG. 2A, the playing system 205 may include a primary timeline 210. In some embodiments, the primary timeline 210 may indicate the current playing position (i.e., the playing progress) of the audio-visual content. For example, the primary timeline 210 may include a playing position indicator 215 to indicate a time point at which the audio-visual content is currently being played.

For example, when the audio-visual content to be played is a recorded content, the length information of the audio-visual content is fixed, and a total length of the timeline may correspond to a total duration of the audio-visual content. In addition, the playing position indicator 215 may be correspondingly set based on the correspondence between the position and the playing time.

In still further examples, when the audio-visual content to be played is a live streaming content whose duration is still increasing, the playing position indicator 215 may, for example, always be set to the rightmost side of the primary timeline 210. In addition, when the user wants to review a specific content that has been broadcast live, the user may, for example, jump back to the corresponding time point by moving the playing position indicator 215.

In some embodiments, as illustrated in FIG. 1, the primary timeline 210 may further present graphical information corresponding to an audio waveform of the audio-visual content. In this way, the user may more conveniently know which portions of the audio-visual content are worth paying attention to, and which portions, such as portions with fewer audio waveforms, may be temporarily ignored. Thus, with the playing system 205, the efficiency of users in obtaining the content may be improved.

In some embodiments, the audio-visual content may be, for example, a record content of the online conference. Correspondingly, as illustrated in FIG. 1, the primary timeline 210 may further present, for example, an interaction identification 220 corresponding to an interaction behavior in the online conference.

The interaction identification 220 may be set at a corresponding position of the primary timeline 210 to indicate that a corresponding interaction behavior occurred at the respective moment. In some embodiments, different graphs of the interaction identification 220 may correspond to different interaction behaviors.

In some embodiments, for example, the primary timeline 210 may include an interaction identification 220 for indicating file sharing in the online conference. Correspondingly, as an example, the interaction identification 220 may have a graphic corresponding to a format of the shared file, such as a thumbnail of the shared file.

In some embodiments, when the user selects the interaction identification 220, the playing system 205 may, for example, guide the user to obtain description information about the file sharing. For example, when the user hovers over the interaction identification 220, for example, with a mouse, the playing system 205 may, for example, indicate information (such as the name, the format, the size, the sharer of the file, etc.) of the shared file in a floating window. In further examples, when the user clicks the interaction identification 220, the playing system 205 may, for example, guide the user to obtain the content of the shared file. For example, the playing system 205 may guide the user to jump to an online viewing interface of the file.

In some embodiments, the primary timeline 210 may include, for example, an interaction identification 220 for indicating online chatting in the online conference. As an example, the online chatting here refers to any suitable chatting based on text, expressions, images, and/or audios with an instant messaging tool of the online conference. Correspondingly, as an example, the graphical identification of the interaction identification 220 may be determined based on the content of the online chatting. Alternatively, as an example, the graphical identification of the interaction identification 220 may be determined based on the graphical identification (e.g., an avatar) of the user participating in the chatting.

In some embodiments, when the user selects the interaction identification 220, the playing system 205 may, for example, guide the user to obtain description information about the online chatting. For example, when the user hovers over the interaction identification 220, for example, with a mouse, the playing system 205 may, for example, indicate information (such as the participant, the content of the online chatting, etc.) of the online chatting in a floating window. In further examples, when the user clicks the interaction identification 220, the playing system 205 may, for example, guide the user to obtain the complete content of the previous chatting. For example, the playing system 205 may guide the user to jump to a viewing interface of the chatting content in the conference.

In some embodiments, the primary timeline 210 may include, for example, an interaction identification 220 for indicating commenting in the online conference. As an example, the commenting here may include any suitable commenting based on text, expressions, images, and/or audios. For example, the user's like may also be understood as a kind of commenting on the corresponding content. Correspondingly, as an example, the graphical identification of the interaction identification 220 may be determined based on the content and/or the type of the commenting. For example, when the commenting is based on an expression, the graphical identification of the interaction identification 220 may be generated based on the expression.

In some embodiments, when the user selects the interaction identification 220, the playing system 205 may, for example, guide the user to obtain description information about the commenting. For example, when the user hovers over the interaction identification 220, for example, with a mouse, the playing system 205 may, for example, indicate information (such as the commenter, the commenting time, the commenting reply, etc.) of the comment in a floating window. In yet further examples, when the user clicks the interaction identification 220, the playing system 205 may, for example, guide the user to jump to a comment viewing interface to obtain richer information about the commenting.

In some embodiments, the primary timeline 210 may further present speaker information indicating a distribution in time of the speech content of at least one speaker associated with the audio-visual content. In this case, the primary timeline 210 may also be taken as a speech timeline of a type.

For example, the primary timeline 210 may assign a corresponding color flag to each speaker. Accordingly, the color distribution on the primary timeline 210 may be configured to indicate which one or more speakers the corresponding time period corresponds to. It should be understood that the primary timeline 210 may indicate the distribution in time of the speech content of the speaker with other suitable patterns.

### Speech Timeline

In some embodiments, as illustrated in FIG. 2A, the playing system 205 may further include, for example, a viewing entry 230 for viewing the speech timeline. In some embodiments, as an example, the viewing entry 230 may indicate a graphical identification (e.g., the avatar) of one or more speakers associated with the audio-visual content.

As illustrated in FIG. 2B, after the user's selection of the viewing entry 230 is received, the playing system 205 may, for example, present a speech timeline 240-1 and a speech timeline 240-2 (individually or collectively referred to as the speech timeline 240).

In some embodiments, the speech timeline 240 may be configured to indicate a distribution in time of the speech content of at least one speaker associated with the audio-visual content. For example, when the speaker made the speech at the corresponding moment, the speech timeline 240 may be filled with a first graph. Conversely, when the speaker did not make the speech at the corresponding moment, the speech timeline 240 may be filled with a second graph. Therefore, the user may intuitively know at which moment the speaker made the speech.

In some embodiments, as illustrated in FIG. 2B, the speech timeline 240 may also similarly present graphical information corresponding to an audio waveform of an audio-visual content portion corresponding to the speaker. In this way, the user may intuitively know at which moments the speaker did not make the speech, and at which moments the speaker made the speech frequently. The user may quickly obtain the desired content with the information.

In some embodiments, the number of the speech timelines 240 may be determined based on the number of speakers participated in the audio-visual content. In some embodiments, the number of speakers may be determined based on the number of terminals participating in the online conference. For example, a plurality of conference participants may have accessed the online conference through a same terminal (or using a same account), then the plurality of participants may be identified as the same speaker, although it may include a plurality of different speakers.

In some embodiments, the number of speakers may be determined based on the number of speakers in the audio-visual content. It should be understood that the corresponding speaker in the audio-visual content may be determined with any suitable speaker recognition technology, which is not intended to be limited in the present disclosure.

In some embodiments, after a selection on the viewing entry 230 is received, the playing system 205 may present the speech timeline 240 corresponding to all speakers of the audio-visual content. Taking FIG. 2B as an example, the audio-visual content may include, for example, two speakers (“Speaker 1” and “Speaker 2”). Correspondingly, the presentation order of the corresponding speech timeline 240-1 and the speech timeline 240-2 in the playing system 205 may be determined based on information of the speaker.

In some examples, the presentation order of the speech timelines may be determined, for example, based on text identifications of the speakers. The text identification may include, for example, the username, or the nickname of the speaker, etc. As an example, the presentation order of the speech timelines may be based on the sorting of the text identifications of the speakers.

In still further examples, the presentation order of the speech timelines may be determined, for example, based on proportions of speech contents of the speakers. For example, when the proportion of the speech content of the “Speaker 1” reaches “70%”, which is greater than the proportion (i.e., “30%”) of the speech content of the “Speaker 2”, the speech timeline 240-1 may be presented, for example, preferentially over the speech timeline 240-2.

In still further examples, the presentation order of the speech timelines may be determined, for example, based on start times of the speech contents of the speakers. For example, the start time of the speech content of the “Speaker 1” is, for example, the first minute after the start of the conference, which is earlier than the start time of the speech content of the “Speaker 2”, such as the third minute after the start of the conference. Accordingly, as an example, the speech timeline 240-1 may be presented preferentially over the speech timeline 240-2.

It should be understood that the plurality of speech timelines 240 may be sorted with other suitable sorting manners, to facilitate the user to more efficiently obtain the desired content.

In some embodiments, the playing system 205 may further present description information of a respective speaker in association with the speech timeline 240. For example, the speech timeline 240-1 may have a text identification (e.g., the username or nickname) of the corresponding speaker. Alternatively, the speech timeline 240-1 may also have a graphical identification (e.g., the avatar) of the corresponding speaker.

In some embodiments, the playing system 205 may further present proportion information of the speech content of a respective speaker in association with at least one speech timeline. The speech timeline 240-1 may include the proportion “XX%” of the speech content of the “Speaker 1”.

In some embodiments, similar to the primary timeline 210, the speech timeline 240 may further present an interaction identification (not illustrated in FIG. 2B) indicating an interaction behavior associated with the corresponding speaker in the online conference.

In some embodiments, the interaction behavior refers to the corresponding interaction behavior in which the corresponding speaker participates, such as the file sharing, the online chatting, or commenting as discussed above. The interaction logic of the interaction identification presented on the speech timeline 240 may be similar to the interaction identification 220 discussed above, and details are not described herein again.

In some embodiments, the speech timeline 240-1 may also be automatically collapsed or expanded in response to the user's selection of the viewing entry 230. For example, the playing system may always provide by default the speech timeline for all speakers, without relying on the selection of the viewing entry 230.

In some embodiments, the playing system 205 may further provide a search entry 250 for the speech timeline. With the search entry 250, the user may initiate a viewing request associated with a specific user.

In some embodiments, after a selection on the viewing entry 250 is received, the playing system 205 may present visual elements associated with all speakers associated with the audio-visual content. The visual element may include, for example, the text identification (e.g., the username or nickname) or the graphical identification (e.g., the avatar) of the speaker.

Furthermore, the playing system 205 may receive the user's selection on a specific visual element of the plurality of visual elements, and determine that the user desires to view the speech timeline of the speaker corresponding to the selected visual element. For example, the user may click the avatar of the “Speaker 1”, such that the playing system 205 may only present the speech timeline 240-1 corresponding to the “Speaker 1” instead of presenting the speech timeline 240-2.

As a further example, the user, for example, may further provide an input indicating the target speaker through the search entry 250. For example, the user may input at least a portion of the nickname or the username of the “Speaker 1” to automatically match the “Speaker 1”, causing the playing system 205 to present the speech timeline 240-1 corresponding to the “Speaker 1” instead of presenting the speech timeline 240-2.

In some embodiments, for example, the search entry 250 may be provided independently of the viewing entry 230. For example, when the viewing entry 230 is not selected, the playing system 205 may also provide the search entry 250 for viewing a specific speaker.

Alternatively, for example, the search entry 250 may be provided dependent on the viewing entry 230. That is, only when the viewing entry 230 is activated and the speech timelines of all speakers are presented, the search entry 250 is provided accordingly for quickly filtering or locating a specific speech timeline.

In some embodiments, the speech timeline 240 may also support various types of user interactions. For example, as illustrated in FIG. 2C, the user may click on a position 260 in the speech timeline 240-1 to indicate that he/she desires to play the audio-visual content from this position.

Accordingly, the playing system 205 may cause the audio-visual content to be played from a time point 270 corresponding to the position 260. In some embodiments, the playing system 205 may cause the audio-visual content to be continuously played from the time point 270. For example, when time point 270 is at the moment “5 minutes and 30 seconds”, then the audio-visual content may be continuously played from “5 minutes and 30 seconds” until the end.

Alternatively, the playing system 205 may also cause an audio-visual content portion corresponding to the “Speaker 1” to be played from the time point 270. That is, the playing system 205 may play only the audio-visual content portion corresponding to the “Speaker 1” on the speech timeline 240-1, and cause it to be played from the time point 270, thereby achieving the effect of listening only to the specific user.

In some embodiments, when the user performs a preset operation on the speech timeline 240-1 (for example, double-clicking the speech timeline 240-1), the playing system 205 may cause the audio-visual content portion corresponding to the “Speaker 1” to be played from the beginning, i.e., only the audio-visual content portion, of the audio-visual content, corresponding to the “Speaker 1” is played.

It should be understood that, for purposes of description, although various examples of the playing system are discussed above with reference to FIGS. 2A-2C, the various characteristics discussed above (e.g., the provision of audio waveforms, the provision of interaction identifications, the provision of the speech timeline, the style of the speech timeline, the interaction of the speech timeline, etc.) may be provided independently or in combination manners different from that illustrated in FIGS. 2A-2C. For example, in the case where the playing system provides the characteristic of the interaction identification, the timeline of the playing system may be in a graphical style similar to the timeline of a conventional playing system, and does not necessarily have to be configured to indicate the audio waveform.

In addition, for example, although the examples illustrated in FIGS. 2A-2C are for reviewing the recorded content, the playing system 205 may also be configured to play the real-time audio-visual content (e.g., the audio-video live stream). Accordingly, for example, the speech timeline discussed above may be configured to indicate a distribution in time of a historical speech content of at least one speaker associated with a historical portion of the real-time audio-visual content. For example, the speech timeline may be presented in a graphical manner, i.e., the distribution in time of the historical speech content of each speaker from the start moment of the live broadcast to the current moment.

### Example Viewing Interface

In some embodiments, embodiments of the present disclosure may further provide a viewing interface for the audio-visual content. For example, the viewing interface may be a reviewing interface of the recorded content, or a live interface of the real-time content. It should be understood that, for the purpose of illustration only, the scenario of “conference recording” is used as an example of viewing the audio-visual content, the scenario is merely an example, and embodiments of the present disclosure may also be applied to other appropriate scenarios.

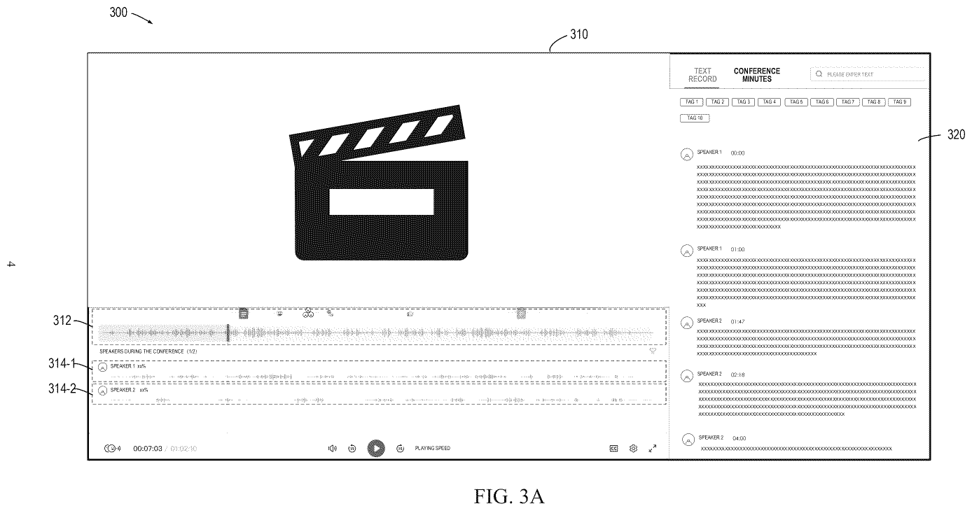

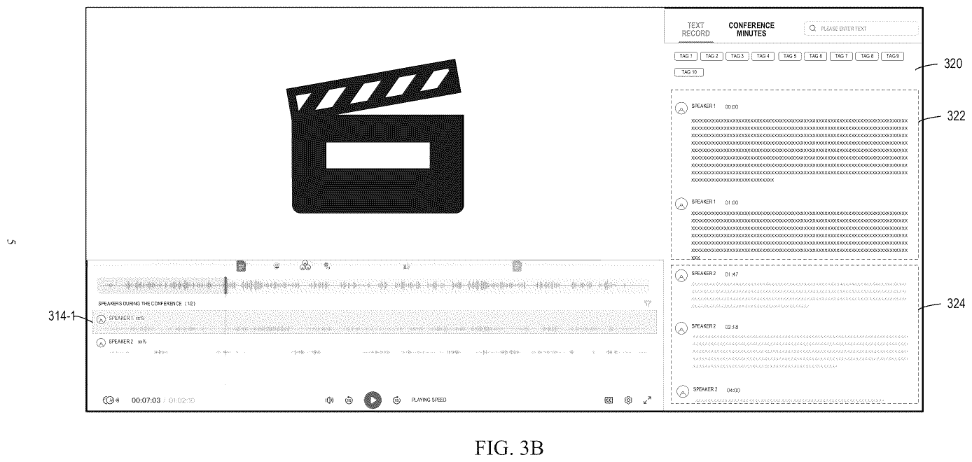

FIG. 3A illustrates an example viewing interface 300 according to some embodiments of the present disclosure. As illustrated in FIG. 3A, the viewing interface 300 may include a play control 310. As an example, the play control 310 may be implemented with the playing system 205 discussed above. As illustrated in FIG. 3A, for example, the play control 310 may include a primary timeline 312 and a speech timeline 314-1 and 314-2 (individually or collectively referred to as the speech timeline 314).

In some embodiments, the viewing interface 300 further includes a text control 320, configured to present a text content corresponding to the audio-visual content. In some embodiments, the text content may be generated based on the audio of the audio-visual content. As an example, the audio-visual content is the conference record, the text content may be generated based on speech recognition of the speech audio of each speaker in the conference. As an example, the audio-visual content is the real-time live content, the text content may be generated based on the real-time speech recognition of each speaker.

In some embodiments, as illustrated in FIG. 3B, the user may, for example, select the speech timeline 314-1. Accordingly, the text content 322 corresponding to the “Speaker 1” may be adjusted to be displayed in the text control 320 highlighted relative to other text contents 324 of other speakers.

In some embodiments, for example, causing the text content 322 to be displayed highlighted relative to other text contents 324 may include increasing a highlighting degree at which the text content 322 is displayed in the text control 320. For example, the display style (e.g., the text color, the background color, the boldness degree, the font size, the underline, etc.) of the text content 322 may be adjusted to be more highlighted. For example, the text content 322 may be bolded or highlighted.

Alternatively, for example, causing the text content 322 to be displayed highlighted relative to other text contents 324 may include decreasing highlighting degrees at which other text contents 324 are displayed in the text control. For example, the display style (e.g., the text color, the background color, the boldness degree, the font size, the underline, etc.) of the text content 324 may be adjusted to be not highlighted. For example, as illustrated in FIG. 3B, the text color of the other text contents 324 may be made gray, thereby forming a contrast with the black text content 322.

As discussed with reference to FIG. 2C, the user may also select a specific position in the speech timeline to trigger the audio-visual content to be played from the corresponding moment. Alternatively, or additionally, when a specific position in the speech timeline is selected, the text content corresponding to the specific position may also be adjusted to be presented in the text control 320 highlighted.

For example, the text content presented in the text control 320 always corresponds to the moment at which the audio-visual content is currently being played. After the user selects a specific moment in the speech timeline, the segment of text content corresponding to the moment (for example, the text corresponding to a certain paragraph spoken by the speaker) may be adjusted to the top of the text disclosure 320, to be presented highlighted. Alternatively, or additionally, the display style of the segment of text content may also be adjusted to make the segment of text content highlighted. For example, one or more words corresponding to the moment may be highlighted.

### Sharing of Clip of Audio-visual Content

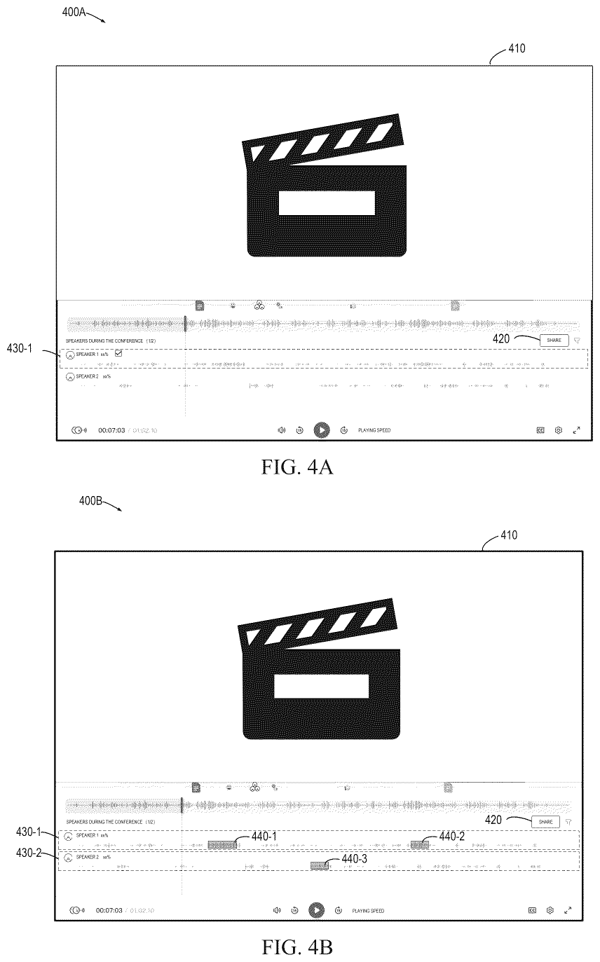

In some embodiments, for example, embodiments of the present disclosure may further support sharing of the clip of audio-visual content based on the speech timeline. As illustrated in FIG. 4A, the user may select one or more speech timelines (e.g., the speech timeline 430-1), of the plurality of speech timelines, in the play control 410 (or the playing system 410) for sharing.

After the selection is received, the clip of audio-visual content corresponding to the speech timeline 430-1 may be generated for sharing. Taking FIG. 4A as an example, after the user selects the speech timeline 430-1 and clicks a sharing entry 420 (i.e., sends a sharing request), the entire speech content of the “Speaker 1” may be used to generate independent clip of audio-visual content, for example, for sharing with other users or organizations.

As a further example, as illustrated in FIG. 4B, the user may also select one or more time segments in the speech timelines 430-1 and 430-2, such as the time segment 440-1, the time segment 440-2 and the time segment 440-3. Accordingly, after the user clicks the sharing entry 420 (i.e., sends the sharing request), a plurality of discrete clips of audio-visual content corresponding to the time segment 440-1, the time segment 440-2 and the time segment 440-3 may be combined to generate independent clip of audio-visual content, for example, for sharing with other users or organizations.

Based on the solution, embodiments of the present disclosure may support the user to more efficiently share the clip of audio-visual content by selecting the speech timeline or the time segment, thereby improving the efficiency of the audio-visual content sharing and improving the efficiency of information acquisition by the shared recipients. In addition, embodiments of the present disclosure further support the user to select discontinuous segments for creation, which further improves the flexibility of sharing the clip of audio-visual content.

### Example Processes

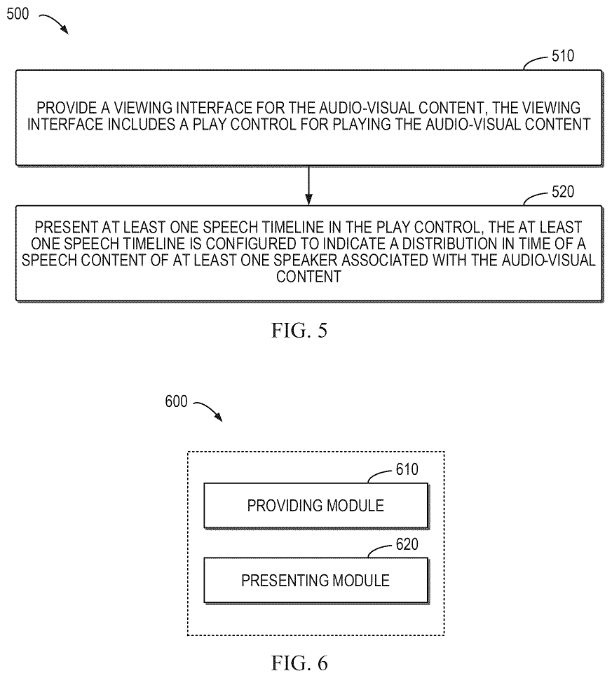

FIG. 5 illustrates a flowchart of an example process 500 for viewing an audio-visual content according to some embodiments of the present disclosure. The process 500 may be implemented at a suitable electronic device. Examples of the electronic device may include, but are not limited to, a desktop computer, a notebook computer, a smart phone, a tablet computer, a personal digital assistant, or a smart wearable device, etc.

As illustrated in FIG. 5, at block 510, the electronic device provides a viewing interface for the audio-visual content. The viewing interface includes a play control for playing the audio-visual content.

At block 520, the electronic device presents at least one speech timeline in the play control. The at least one speech timeline is configured to indicate a distribution in time of a speech content of at least one speaker associated with the audio-visual content.

In some embodiments, the viewing interface further includes a text control for presenting a text content corresponding to the audio-visual content, and the text content is generated based on an audio of the audio-visual content.

In some embodiments, the method further includes in response to a selection on a first speech timeline of the at least one speech timeline, causing a first text content corresponding to a first speaker in the text content to be displayed in the text control highlighted relative to second text contents of other speakers. The first speech timeline corresponds to the first speaker.

In some embodiments, causing the first text content corresponding to the first speaker in the text content to be displayed in the text control highlighted relative to the second text contents of other speakers includes increasing a highlighting degree at which the first text content is displayed in the text control; and/or decreasing a highlighting degree at which the second text content is displayed in the text control.

In some embodiments, the method further includes receiving a selection on a first position in a first speech timeline of the at least one speech timeline; and causing a text content corresponding to the first position in the text content to be presented in the text control highlighted.

In some embodiments, presenting the at least one speech timeline in the play control includes: presenting, in the play control, a viewing entry for viewing a speech timeline; and in response to a selection on the viewing entry, presenting the at least one speech timeline in the play control.

In some embodiments, the at least one speech timeline includes a plurality of speech timelines. A presentation order of the plurality of speech timelines in the play control is determined based on at least one of: text identifications of a plurality of speakers corresponding to the plurality of speech timelines, proportions of speech contents of the plurality of speakers, or start times of speech contents of the plurality of speakers.

In some embodiments, presenting the at least one speech timeline in the play control includes receiving a viewing request associated with a target speaker; and presenting a target speech timeline corresponding to the target speaker. The target speech timeline is configured to indicate a distribution in time of a target speech content of the target speaker.

In some embodiments, receiving the viewing request associated with the target speaker includes presenting a plurality of visual elements associated with a plurality of speakers associated with the audio-visual content; and receiving the viewing request associated with the target speaker based on a predetermined operation on a target visual element, of the plurality of visual elements, corresponding to the target speaker.

In some embodiments, receiving the viewing request associated with the target speaker includes receiving the viewing request associated with the target speaker based on an input indicating the target speaker.

In some embodiments, the method further includes receiving a selection on a second position in a first speech timeline of the at least one speech timeline; and causing a corresponding portion of the audio-visual content to be played from a time point corresponding to the second position.

In some embodiments, the first speech timeline corresponds to the first speaker, and causing the corresponding portion of the audio-visual content to be played from the time point corresponding to the second position includes causing the audio-visual content to be continuously played from the time point; or causing an audio-visual content portion, of the audio-visual content, corresponding to the first speaker to be played from the time point.

In some embodiments, the method further includes presenting description information of a respective speaker in association with the at least one speech timeline. The description information is generated based on a text identification and/or a graphical identification of the speaker.

In some embodiments, the method further includes presenting proportion information of a speech content of a respective speaker in association with the at least one speech timeline.

In some embodiments, the play control further includes a primary timeline for presenting graphical information corresponding to an audio waveform of the audio-visual content.

In some embodiments, the audio-visual content is an audio-visual record for an online conference. The play control further includes a primary timeline configured to present a first interaction identification corresponding to a first interaction behavior in the online conference.

In some embodiments, the at least one speech timeline further presents a second interaction identification indicating a second interaction behavior associated with a corresponding speaker in the online conference.

In some embodiments, the first interaction behavior and/or the second interaction behavior includes at least one of: file sharing, online chatting, or commenting.

In some embodiments, the method further includes in response to a first selection on the first interaction identification, presenting first description information for the first interaction behavior; and/or in response to a second selection on the second interaction identification, presenting second description information for the second interaction behavior.

In some embodiments, the method further includes receiving a selection on at least one time segment in the at least one speech timeline; and causing, based on a first sharing request associated with the at least one time segment, a first clip of audio-visual content corresponding to the at least one time segment to be generated for sharing.

In some embodiments, the method further includes receiving a selection on a set of speech timelines in the at least one speech timeline, the set of speech timelines including one or more speech timelines; and causing, based on a second sharing request associated with the set of speech timelines, a second clip of audio-visual content corresponding to the set of speech timelines to be generated for sharing.

In some embodiments, the audio-visual content includes a real-time audio-visual content. The at least one speech timeline is configured to indicate a distribution in time of a historical speech content of at least one speaker associated with a historical portion of the real-time audio-visual content.

### Example Apparatus and Device

Embodiments of the present disclosure further provide a corresponding apparatus for implementing the above method or process. FIG. 6 illustrates a schematic block diagram of an apparatus 600 for viewing an audio-visual content according to some embodiments of the present disclosure.

As illustrated in FIG. 6, the apparatus 600 includes a providing module 610. The providing module 610 configured to provide a viewing interface for the audio-visual content. The viewing interface includes a play control for playing the audio-visual content.

In addition, the apparatus 600 further includes a presenting module 620. The presenting module 620 is configured to present at least one speech timeline in the play control. The at least one speech timeline is configured to indicate a distribution in time of a speech content of at least one speaker associated with the audio-visual content.

In some embodiments, the viewing interface further includes a text control for presenting a text content corresponding to the audio-visual content, and the text content is generated based on an audio of the audio-visual content.

In some embodiments, the presenting module 620 is further configured to: in response to a selection on a first speech timeline of the at least one speech timeline, cause a first text content corresponding to a first speaker in the text content to be displayed in the text control highlighted relative to second text contents of other speakers. The first speech timeline corresponds to the first speaker.

In some embodiments, causing the first text content corresponding to the first speaker in the text content to be displayed in the text control highlighted relative to the second text contents of other speakers includes increasing a highlighting degree at which the first text content is displayed in the text control; and/or decreasing a highlighting degree at which the second text content is displayed in the text control.

In some embodiments, the presenting module 620 is further configured to receive a selection on a first position in a first speech timeline of the at least one speech timeline; and cause a text content corresponding to the first position in the text content to be presented in the text control highlighted.

In some embodiments, the presenting module 620 is further configured to present, in the play control, a viewing entry for viewing a speech timeline; and in response to a selection on the viewing entry, present the at least one speech timeline in the play control.

In some embodiments, the at least one speech timeline includes a plurality of speech timelines. A presentation order of the plurality of speech timelines in the play control is determined based on at least one of: text identifications of a plurality of speakers corresponding to the plurality of speech timelines, proportions of speech contents of the plurality of speakers, or start times of speech contents of the plurality of speakers.

In some embodiments, the presenting module 620 is further configured to receive a viewing request associated with a target speaker; and present a target speech timeline corresponding to the target speaker. The target speech timeline is configured to indicate a distribution in time of a target speech content of the target speaker.

In some embodiments, the presenting module 620 is further configured to present a plurality of visual elements associated with a plurality of speakers associated with the audio-visual content; and receive the viewing request associated with the target speaker based on a predetermined operation on a target visual element, of the plurality of visual elements, corresponding to the target speaker.

In some embodiments, the presenting module 620 is further configured to receive the viewing request associated with the target speaker based on an input indicating the target speaker.

In some embodiments, the presenting module 620 is further configured to receive a selection on a second position in a first speech timeline of the at least one speech timeline; and cause a corresponding portion of the audio-visual content to be played from a time point corresponding to the second position.

In some embodiments, the first speech timeline corresponds to the first speaker. The presenting module 620 is further configured to cause the audio-visual content to be continuously played from the time point; or cause an audio-visual content portion, of the audio-visual content, corresponding to the first speaker to be played from the time point.

In some embodiments, the presenting module 620 is further configured to present description information of a respective speaker in association with the at least one speech timeline. The description information is generated based on a text identification and/or a graphical identification of the speaker.

In some embodiments, the presenting module 620 is further configured to present proportion information of a speech content of a respective speaker in association with the at least one speech timeline.

In some embodiments, the play control further includes a primary timeline for presenting graphical information corresponding to an audio waveform of the audio-visual content.

In some embodiments, the audio-visual content is an audio-visual record for an online conference. The play control further includes a primary timeline configured to present a first interaction identification corresponding to a first interaction behavior in the online conference.

In some embodiments, the at least one speech timeline further presents a second interaction identification indicating a second interaction behavior associated with a corresponding speaker in the online conference.

In some embodiments, the first interaction behavior and/or the second interaction behavior includes at least one of: file sharing, online chatting, or commenting.

In some embodiments, the presenting module 620 is further configured to in response to a first selection on the first interaction identification, present first description information for the first interaction behavior; and/or in response to a second selection on the second interaction identification, present second description information for the second interaction behavior.

In some embodiments, the presenting module 620 is further configured to receive a selection on at least one time segment in the at least one speech timeline; and cause, based on a first sharing request associated with the at least one time segment, a first clip of audio-visual content corresponding to the at least one time segment to be generated for sharing.

In some embodiments, the presenting module 620 is further configured to receive a selection on a set of speech timelines in the at least one speech timeline, the set of speech timelines including one or more speech timelines; and cause, based on a second sharing request associated with the set of speech timelines, a second clip of audio-visual content corresponding to the set of speech timelines to be generated for sharing.

In some embodiments, the audio-visual content includes a real-time audio-visual content. The at least one speech timeline is configured to indicate a distribution in time of a historical speech content of at least one speaker associated with a historical portion of the real-time audio-visual content.

The units included in the apparatus 600 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

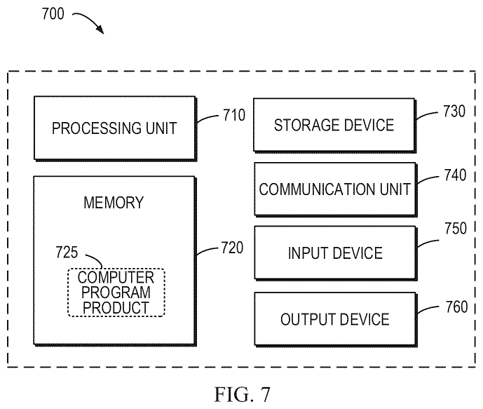

FIG. 7 illustrates a block diagram of a computing device/server 700 in which one or more embodiments of the present disclosure may be implemented. It should be understood that the computing device/server 700 illustrated in FIG. 7 is merely an example and should not constitute any limitation on the functionality and scope of the embodiments described herein.

As illustrated in FIG. 7, the computing device/server 700 is in the form of a general-purpose computing device. Components of the computing device/server 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, a plurality of processing units execute computer-executable instructions in parallel to improve the parallel processing capability of computing device/server 700.

Computing device/server 700 typically includes a plurality of computer storage media. Such media may be any available media accessible by the computing device/server 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data (e.g., training data for training) and may be accessed within computing device/server 700.

The computing device/server 700 may further include additional removable/non-removable, volatile/non-volatile storage media. Although not illustrated in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not illustrated) by one or more data media interfaces. The memory 720 may include a computer program product 725 having one or more program modules configured to perform various methods or actions of various embodiments of the present disclosure.

The communications unit 740 implements communications with other computing devices over a communications medium. Additionally, the functionality of components of the computing device/server 700 may be implemented in a single computing cluster or a plurality of computing machines capable of communicating over a communication connection. Thus, the computing device/server 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. Computing device/server 700 may also communicate with one or more external devices (not illustrated) as needed, external devices such as storage devices, display devices, etc., communicate with one or more devices that enable a user to interact with computing device/server 700, or communicate with any device (e.g., network card, modem, etc.) that enables computing device/server 700 to communicate with one or more other computing devices. Such communication may be performed via an input/output (I/O) interface (not illustrated).

According to example implementations of the present disclosure, there is provided a computer-readable storage medium having one or more computer instructions stored thereon, wherein one or more computer instructions are executed by a processor to implement the method described above.

Aspects of the present disclosure are described herein with reference to flowcharts and/or block diagrams of methods, apparatuses (systems), and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may also be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the implementations disclosed herein.

1. A method for viewing an audio-visual content, comprising:
providing a viewing interface for the audio-visual content, the viewing interface comprising a play control for playing the audio-visual content; and
presenting at least one speech timeline in the play control, the at least one speech timeline being configured to indicate a distribution in time of a speech content of at least one speaker associated with the audio-visual content.

2. The method of claim 1, wherein the viewing interface further comprises a text control for presenting a text content corresponding to the audio-visual content, and the text content is generated based on an audio of the audio-visual content.

3. The method of claim 2, wherein the method further comprises:
in response to a selection on a first speech timeline of the at least one speech timeline, causing a first text content corresponding to a first speaker in the text content to be displayed in the text control highlighted relative to second text contents of other speakers, wherein the first speech timeline corresponds to the first speaker.

4. The method of claim 3, wherein causing the first text content corresponding to the first speaker in the text content to be displayed in the text control highlighted relative to the second text contents of other speakers comprises:
increasing a highlighting degree at which the first text content is displayed in the text control; and/or
decreasing a highlighting degree at which the second text content is displayed in the text control.

5. The method of claim 2, wherein the method further comprises:
receiving a selection on a first position in a first speech timeline of the at least one speech timeline; and
causing a text content corresponding to the first position in the text content to be presented in the text control highlighted.

6. The method of claim 1, wherein presenting the at least one speech timeline in the play control comprises:
presenting, in the play control, a viewing entry for viewing a speech timeline; and
in response to a selection on the viewing entry, presenting the at least one speech timeline in the play control.

7. The method of claim 1, wherein the at least one speech timeline comprises a plurality of speech timelines, and a presentation order of the plurality of speech timelines in the play control is determined based on at least one of:
text identifications of a plurality of speakers corresponding to the plurality of speech timelines,
proportions of speech contents of the plurality of speakers, or
start times of speech contents of the plurality of speakers.

8. The method of claim 1, wherein presenting the at least one speech timeline in the play control comprises:
receiving a viewing request associated with a target speaker; and
presenting a target speech timeline corresponding to the target speaker, the target speech timeline being configured to indicate a distribution in time of a target speech content of the target speaker.

9. The method of claim 8, wherein receiving the viewing request associated with the target speaker comprises:
presenting a plurality of visual elements associated with a plurality of speakers associated with the audio-visual content; and
receiving the viewing request associated with the target speaker based on a predetermined operation on a target visual element, of the plurality of visual elements, corresponding to the target speaker, or
wherein receiving the viewing request associated with the target speaker comprises:
receiving the viewing request associated with the target speaker based on an input indicating the target speaker.

10. (canceled)

11. The method of claim 1, wherein the method further comprises:
receiving a selection on a second position in a first speech timeline of the at least one speech timeline; and
causing a corresponding portion of the audio-visual content to be played from a time point corresponding to the second position.

12. The method of claim 11, wherein the first speech timeline corresponds to a first speaker, and causing the corresponding portion of the audio-visual content to be played from the time point corresponding to the second position comprises:
causing the audio-visual content to be continuously played from the time point; or
causing an audio-visual content portion, of the audio-visual content, corresponding to the first speaker to be played from the time point.

13. The method of claim 1, wherein the method further comprises:
presenting description information of a respective speaker in association with the at least one speech timeline, the description information being generated based on a text identification and/or a graphical identification of the speaker; or
or wherein the method further comprises:
presenting proportion information of a speech content of a respective speaker in association with the at least one speech timeline.

14. (canceled)

15. The method of claim 1, wherein the play control further comprises a primary timeline for presenting graphical information corresponding to an audio waveform of the audio-visual content.

16. The method of claim 1, wherein the audio-visual content is an audio-visual record for an online conference, and the play control further comprises a primary timeline configured to present a first interaction identification corresponding to a first interaction behavior in the online conference.

17. The method of claim 16, wherein the at least one speech timeline further presents a second interaction identification indicating a second interaction behavior associated with a corresponding speaker in the online conference, or
wherein the first interaction behavior and/or the second interaction behavior comprises at least one of: file sharing, online chatting, or commenting.

18. (canceled)

19. The method of claim 16, wherein the method further comprises:
in response to a first selection on the first interaction identification, presenting first description information for the first interaction behavior; and/or
in response to a second selection on the second interaction identification, presenting second description information for the second interaction behavior.

20. The method of claim 1, wherein the method further comprises:
receiving a selection on at least one time segment in the at least one speech timeline; and
causing, based on a first sharing request associated with the at least one time segment, a first clip of audio-visual content corresponding to the at least one time segment to be generated for sharing,
or
wherein the method further comprises:
receiving a selection on a set of speech timelines in the at least one speech timeline, the set of speech timelines comprising one or more speech timelines; and
causing, based on a second sharing request associated with the set of speech timelines, a second clip of audio-visual content corresponding to the set of speech timelines to be generated for sharing.

21. (canceled)

22. The method of claim 1, wherein the audio-visual content comprises a real-time audio-visual content, and the at least one speech timeline is configured to indicate a distribution in time of a historical speech content of at least one speaker associated with a historical portion of the real-time audio-visual content.

23. (canceled)

24. A playing system, comprising:
a primary timeline, indicating a current playing position of an audio-visual content; and
at least one speech timeline, configured to indicate a distribution in time of a speech content of at least one speaker associated with the audio-visual content.

25-30. (canceled)

31. An electronic device, comprising:
at least one processing unit; and
at least one memory coupled to the at least one processing unit and storing instructions for execution by the at least one processing unit, the instructions, when executed by the at least one processing unit, causing the device to perform operations comprising:
providing a viewing interface for the audio-visual content, the viewing interface comprising a play control for playing the audio-visual content; and
presenting at least one speech timeline in the play control, the at least one speech timeline being configured to indicate a distribution in time of a speech content of at least one speaker associated with the audio-visual content.

32. (canceled)
